(19) United States
(12) Patent Application Publication
(10) Pub. No.: US 2009/0268640 A1
(43) Pub. Date: Oct. 29, 2009

(54) COMMUNICATION SYSTEM AND METHOD THEREOF

(75) Inventors: Zse-Hong TSAI, Taipei City (TW); Chiu-Chan HSU, Taipei City (TW); Min-Jhe WU, Taipei County (TW)

Correspondence Address: RABIN & Berdo, PC, 1101 14TH STREET, NW, SUITE 500, WASHINGTON, DC, 20005, US

(73) Assignees: Quanta Computer Inc., Tao Yuan Shien (TW); National Taiwan University, Taipei (TW)

(21) Appl. No.: 12/389,912

(22) Filed: Feb. 20, 2009

(30) Foreign Application Priority Data
Apr. 28, 2008 (TW) 097115607

(51) Int. Cl. H04W 4/16; H04L 12/16

(52) U.S. Cl. 370/262; 370/338

(57) ABSTRACT

A communication method is provided. Firstly, whether the called-party side communication device is inside an area is judged. When the called-party side communication device is inside the area, the first communication link is established through a wireless local network for the caller side communication device to communicate with the called-party side communication device. When the called-party side communication device is outside the area, a second communication link is established through the mobile network communication for the caller side communication device to communicate with the called-party side communication device. When the caller side communication device communicates with the called-party side communication device and the location of the called-party side communication device is switched between being inside and being outside the area, the first communication link is switched to the second communication link or the second communication link is switched to the first communication link by way of multi-party call operation.

This application claims the benefit of Taiwan application Serial No. 97115607, filed Apr. 28, 2008, the subject matter of which is incorporated herein by reference.

### BACKGROUND OF THE INVENTION

1. Field of the Invention

The invention relates in general to a communication system, and more particularly to a communication system capable of selectively establishing one or more than one communication link to connect two communication devices according to the signal intensity of a wireless local network communication.

2. Description of the Related Art

IP private branch exchange (PBX) having Internet protocol (IP) transmission function has been widely used in business telephone system. Normally, the IP PBX is linked to each internal extension of a business telephone system and is further linked to an external telephone system via a network or a public switched telephone network (PSTN). Thus, the IP PBX controls and transfers the telephone communication between internal extensions of a business telephone system and between internal extensions of the business telephone system and external telephones.

In many practical applications, the IP PBX provided by a mobile network communication provider is integrated with the mobile network communication adapted by the provider, the business internal extension can be a mobile extension, and the mobile extension and the IP PBX is connected through the service provided by the mobile network communication provider. Regardless an incoming call comes from inside or outside the business, the incoming call can be connected to those staffs that often travel between different places (such as marketing representatives or engineers) through the mobile network communication.

In a conventional communication system, after a staff holding a mobile extension enters the business, the communication between the mobile extension and the IP PBX is still connected through the mobile network communication. Thus, the mobile extension will incur more communication cost. Therefore, how to provide a communication system incurring lower cost but having higher efficiency is a focus in the field of communication.

### SUMMARY OF THE INVENTION

The invention is directed to a communication system and a communication method thereof. Compared with conventional communication system, the communication system of the invention enables the communication link between a mobile extension and a communication system to be seamlessly switched between a mobile network communication and a wireless local network communication, hence reducing the communication cost of mobile extension.

According to a first aspect of the present invention, a communication system is provided for enabling the caller side communication device and the called-party side communication device to communicate with each other. The called-party side communication device comprises a first communication module and a second communication module, wherein the first communication module and the second communication module support a wireless local network communication and a mobile network communication respectively. The communication system comprises a virtual secretary system and a business telephone system. The virtual secretary system judges whether the called-party side communication device is inside the area of the wireless local network and determines whether to establish a first communication link on the wireless local network for enabling the virtual secretary system and the first communication module to communicate with each other or establish a second communication link on the mobile network for enabling the virtual secretary system and the second communication module to communicate with each other. The business telephone system enables the caller side communication device and the virtual secretary system to communicate with each other in response to a ringing event. When the caller side communication device and the virtual secretary system communicates with each other, the virtual secretary system further establishes one of the first communication link and the second communication link for enabling the caller side communication device and the called-party side communication device to communicate with each other. When the caller side communication device and the virtual secretary system communicate with each other and the location of the called-party side communication device is switched between being inside and being outside the area, the virtual secretary system further switches the first communication link to the second communication link or switches the second communication link to the first communication link by way of multi-party call operation, such that the caller side communication device and the called-party side communication device keep communicating with each other.

According to a second aspect of the present invention, a communication method is provided. Firstly, whether the called-party side communication device is inside an area is judged in response to a ringing event. When the called-party side communication device is inside the area, the first communication link is established through a wireless local network for enabling the caller side communication device and the called-party side communication device to communicate with each other. When the called-party side communication device is outside the area, a second communication link is established through the mobile network communication for enabling the caller side communication device and the called-party side communication device to communicate with each other. When the caller side communication device communicates with the called-party side communication device and the location of the called-party side communication device is switched between being inside and being outside the area, the first communication link is switched to the second communication link or the second communication link is switched to the first communication link by way of multi-party call operation, such that the caller side communication device and the called-party side communication device keep communicating with each other.

The invention will become apparent from the following detailed description of the preferred but non-limiting embodiments. The following description is made with reference to the accompanying drawings.

### BRIEF DESCRIPTION OF THE DRAWINGS

FIG. 1A and FIG. 1B show a communication system according to an embodiment of the invention;

FIG. 2A˜FIG. 2C show a communication system according to a first embodiment of the invention;

FIG. 3A and FIG. 3B show a flowchart of a communication method according to a first embodiment of the invention;

FIG. 4A˜4C show a communication system according to second embodiment of the invention; and

FIG. 5A and FIG. 5B show a flowchart of a communication method according to a second embodiment of the invention.

### DETAILED DESCRIPTION OF THE INVENTION

The communication system of the present embodiment of the invention has a virtual secretary system for connecting with a mobile extension and a business telephone system and managing a communication link between the virtual secretary system and the mobile extension. Thus, the communication link between the virtual secretary system and the mobile extension can be seamlessly switched through the multi-party call function of the virtual secretary system.

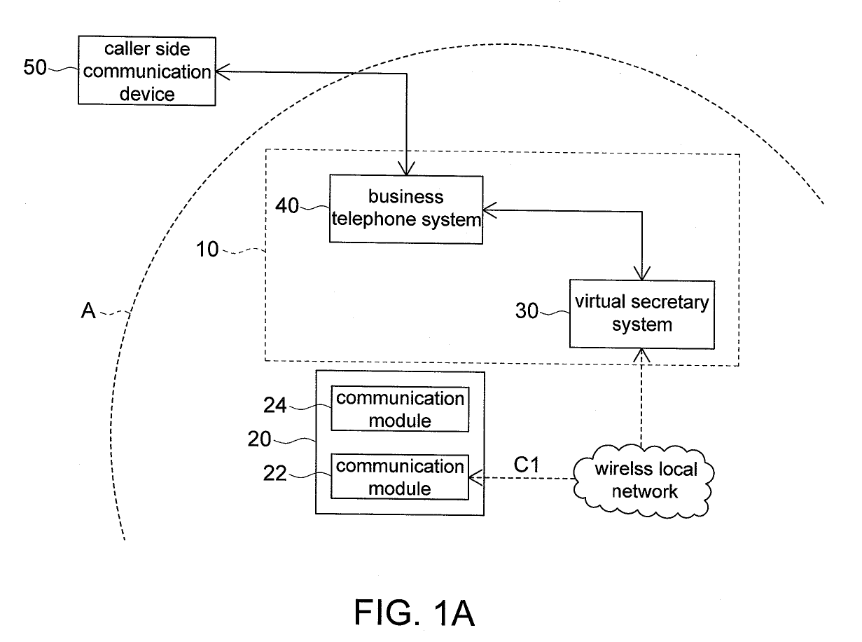

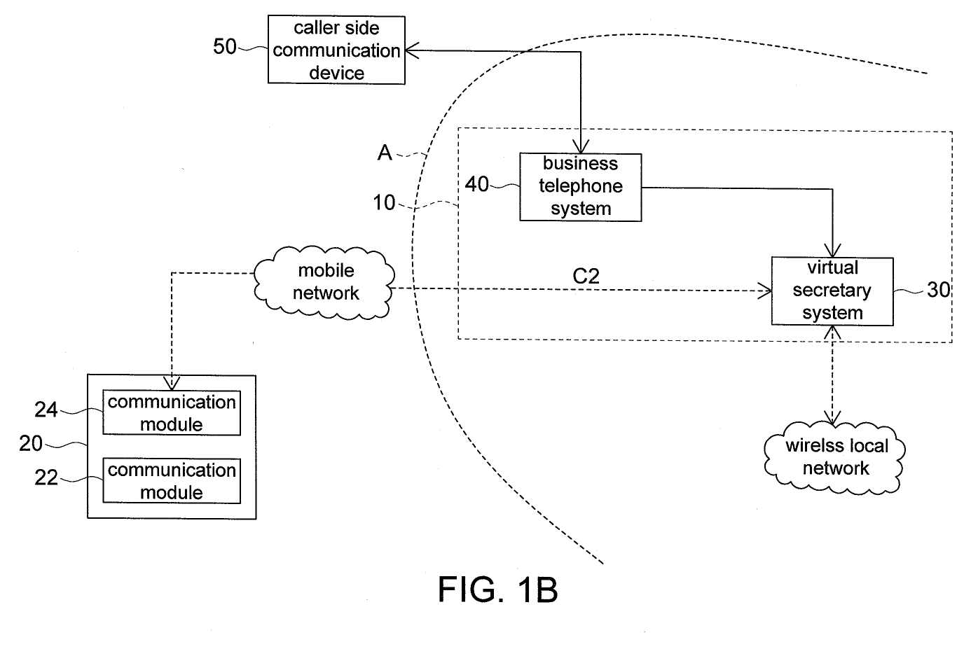

Referring to FIG. 1A and FIG. 1B, a communication system according to an embodiment of the invention is shown. The communication system 10 connects a caller side communication device 50 and a called-party side communication device 20, such that the caller holding the caller side communication device 50 and the callee holding the called-party side communication device 20 communicate with each other. The communication system 10 comprises a virtual secretary system 30 and a business telephone system 40. The called-party side communication device 20, such as a hand-held dual-mode communication device, comprises two communication modules 22 and 24. The communication modules 22 and 24 respectively support a wireless local network communication and a mobile network communication.

The caller side communication device 50 triggers a ringing event in response to the caller's operation. The ringing event, for example, is an event when a caller makes a call to the business telephone 40 and keys in a particular extension number. The caller side communication device 50, for example, makes a call to the business telephone system 40 through a public switched telephone network (PSTN). The business telephone system 40, in response to the ringing event, connects the call made by the caller and transfers the call to the virtual secretary system 30 for enabling the caller side communication device 50 and the virtual secretary system 30 to communicate with each other.

The virtual secretary system 30 judges whether the called-party side communication device 20 is inside the coverage area A of the wireless local network and determines whether to establish a communication link C1 (as indicated in FIG. 1A) on the wireless local network for enabling the virtual secretary system 30 and communication module 22 to communicate with each other or establish a communication link C2 (as indicated in FIG. 1B) on the mobile network for enabling the virtual secretary system 30 and the communication module 24 to communicate with each other. When the called-party side communication device 20 is inside the area A, the virtual secretary system 30 establishes the communication link C1 on the wireless local network for enabling the virtual secretary system 30 and the communication module 22 to communicate with each other. Thus, a three-party communication link is formed among the caller side communication device 50, the virtual secretary system 30 and the communication module 22 for enabling the caller and the callee to communicate with each other.

When the called-party side communication device 20 is outside the area A (as indicated in FIG. 1B), the virtual secretary system 30 establishes a communication link C2 through a mobile network for enabling the virtual secretary system 30 and communication module 24 to communicate with each other. Thus, a three-party communication link is formed among the caller side communication device 50, the virtual secretary system 30 and communication module 24 for enabling the caller and the callee to communicate with each other.

When the caller side communication device 50 and the virtual secretary system 30 communicate with each other and the location of the called-party side communication device 20 is switched between being inside and being outside the area A, the virtual secretary system 30 switches the communication link C1 to the communication link C2 or switches the communication link C2 to the communication link C1 by way of multi-party call operation, such that the caller side communication device 50 and the called-party side communication device 20 keep communicating with each other. A number of embodiments are disclosed below for elaborating the communication system of the present embodiment of the invention.

### First Embodiment

In the present embodiment of the invention, a communication device is moved from a place inside the coverage of the wireless local network communication to a place outside the coverage of the wireless local network communication, and the communication link between the virtual secretary system and the called-party side communication device is seamlessly switched from a wireless local network communication link to a mobile network communication link.

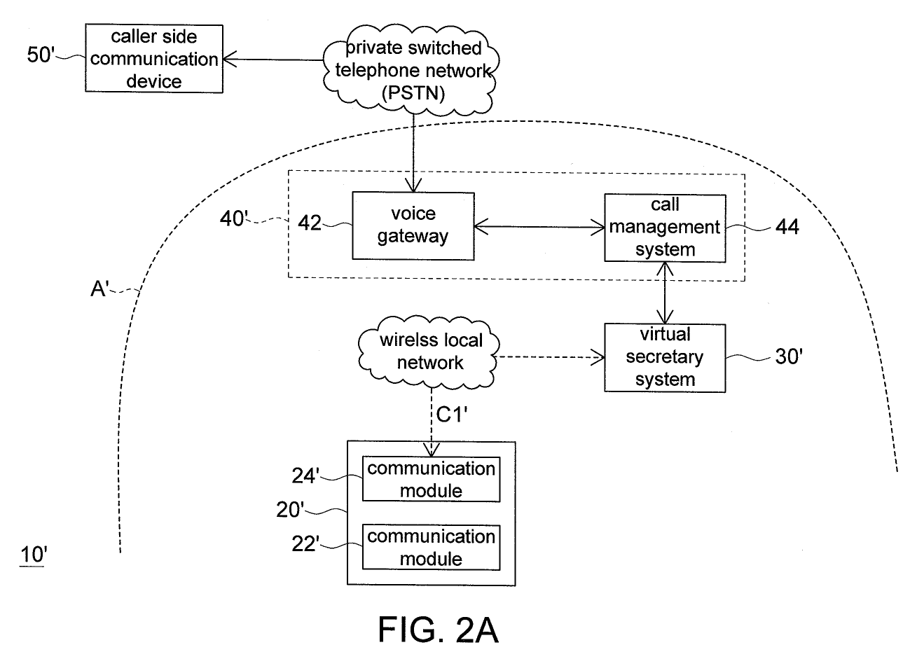

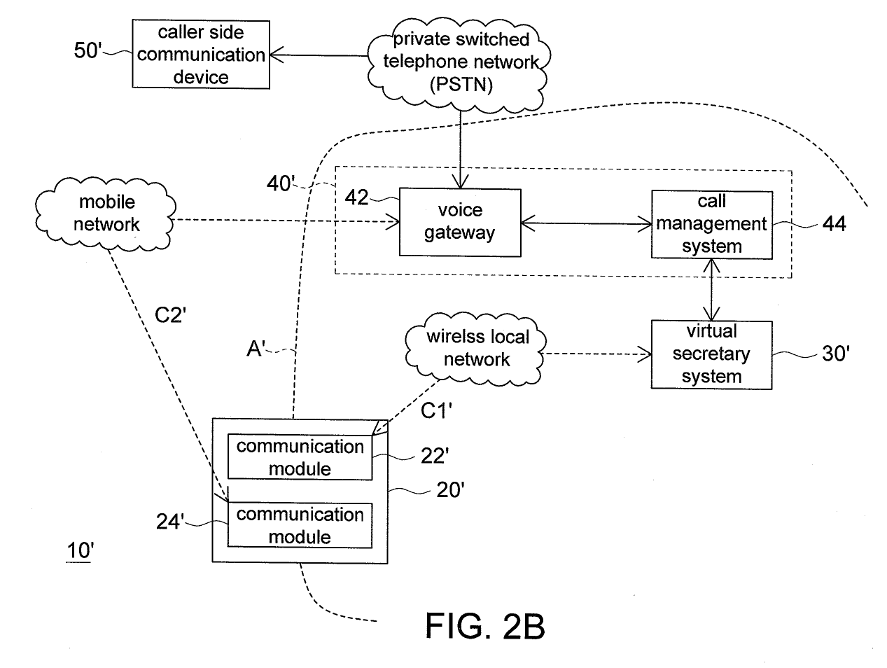

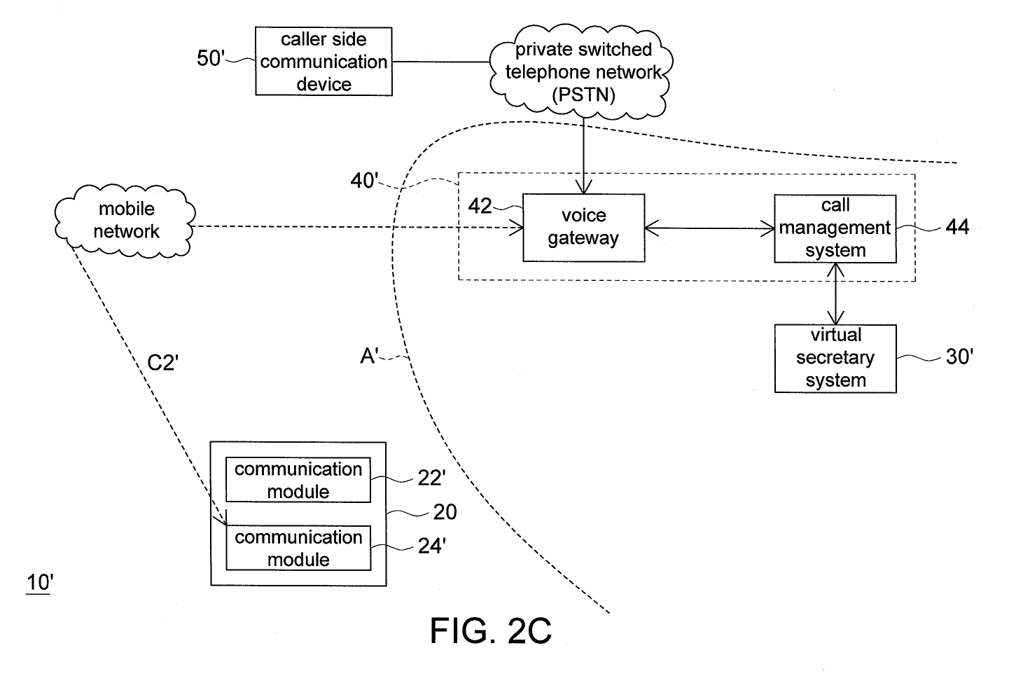

Referring to FIG. 2A, a communication system according to a first embodiment of the invention is shown. As indicated in FIG. 2A, the called-party side communication device 20′ is inside the coverage area A′ of the wireless local network communication. Meanwhile, protocol registration on the application layer is executed by the communication module 22′ supporting wireless local network communication of the called-party side communication device 20′ to the virtual secretary system 30. For example, the application layer protocol of the called-party side communication device 20′ and the virtual secretary system 30′ is a session initiation protocol (SIP). According to the registration record of the called-party side communication device 20′, the virtual secretary system 30′ determines whether the called-party side communication device 20′ is inside the area A′ and whether the SIP communication is applicable between the called-party side communication device 20′ and the virtual secretary system 30′.

The virtual secretary system 30′ can be registered in the business telephone system 40′ according to the extension information corresponding to the called-party side communication device 20′. On the part of the business telephone system 40′, the virtual secretary system 30′ is substantially a business internal extension, and the virtual secretary system 30′ corresponds to the extension of the callee. After the virtual secretary system 30′ is registered in the business telephone system 40′, the business telephone system 40′, in response to the ringing event triggered by the caller, transfers the call made by the caller side communication device 50′ to the virtual secretary system 30′.

For example, the business telephone system 40′, being an Internet protocol private branch exchange (IP PBX), comprises a voice gateway 42 and a call management system 44. The voice gateway 42, for example, has a PSTN module for answering the call made by the caller side communication device 50′ through the PSTN network. The voice gateway 42 further converts the data between PSTN and SIP for enabling the caller side communication device 50′ and the call management system 44 to communicate with each other through the voice gateway 42. The call management system 44, in response to the extension number called by the caller side communication device 50′, transfers the call made by the caller side communication device 50′ to the virtual secretary system 30′.

The virtual secretary system 30′ determines whether the called-party side communication device 20′ is inside the area A′ according to the SIP registration record between the called-party side communication device 20′ and the virtual secretary system 30′. When the virtual secretary system 30′ judges that the called-party side communication device 20′ is inside the area A′, the virtual secretary system 30′ makes a call via internet protocol (IP) to the communication module 22′ through the wireless local network. After the callee holding the called-party side communication device 20′ answers the call via IP made to the communication module 22′ by the virtual secretary system 30′, an SIP communication link C1′ is established between the virtual secretary system 30′ and the communication module 22′ for enabling the communication module 22′ and the virtual secretary system 30′ to communicate with each other. Thus, a three-party communication link is formed among the communication module 22′, the virtual secretary system 30′ and the caller side communication device 50′ for enabling the caller and the callee to communicate with each other through the three-party communication link.

The communication module 22′ further detects the signal intensity of the wireless local network around the communication module 22′ (so as to detect the boundary of the coverage area A′ of the wireless local network) and judges whether the signal intensity of wireless local network continues to be higher than a threshold value (that is the communication module 22′ is within the coverage area A′), and drives the virtual secretary system 30′ to establish a mobile network communication link C2′ on the mobile network. The threshold value, for example, is specified by the user, and the magnitude of the threshold value is related to the quality of the call communication operated through the SIP communication link C1′.

In an operational application, when the callee moves to the boundary of the area A′ from the inside of the area A′, the signal intensity of the wireless local network communication detected by the communication module 22′ is decayed and lower than the threshold value as indicated in FIG. 2B. In other words, the communication module 22′ is getting close to the edge of the coverage area A′. Thus, with the existence of the SIP communication link C1′, the virtual secretary system 30′ makes mobile phone calls to the communication module 24′ through the mobile network.

The virtual secretary system 30′ makes mobile phones to the communication module 24′ through the voice gateway 42. After the callee holding the called-party side communication device 20′ answers the mobile phone call made to the communication module 24′ by the virtual secretary system 30′, a mobile network communication link C2′ is established between the virtual secretary system 30′ and the communication module 22′ for enabling the communication module 24′ and the virtual secretary system 30′ to communicate with each other. Thus, a four-party communication link is formed among the virtual secretary system 30′, the communication module 22′, 24′ and the caller side communication device 50′ for enabling the caller and the callee to communicate with each other through the four-party communication link.

The virtual secretary system 30′ further selectively terminates one of the SIP communication link C1′ and the mobile network communication link C2′. In an operational application, the callee moves to the outside of the area A′ from the boundary of the area A′ for enabling the called-party side communication device 20′ to leave the area A′ as indicated in FIG. 2C. Thus, the virtual secretary system 30′ terminates the SIP communication link C1′. Thus, the caller and the callee communicate with each other through a three-party communication link among the caller side communication device 50′, the virtual secretary system 30′ and the communication module 24′.

In another operational application, the callee starts to move to the inside (as indicated in FIG. 2A) of the area A′ from the boundary (as indicated in FIG. 2B) of the area A′, the intensity of the signal on the local wireless communication network around the communication module 22′ is substantially larger than the threshold value. Thus, the virtual secretary system 30′ terminates the mobile network communication link C2′. Thus, the caller and the callee communicate with each other through a three-party communication link among the caller side communication device 50′, the virtual secretary system 30′ and the communication module 22′.

According to the above operation, when the location of the called-party side communication device 20′ is switched between being inside and being outside the area A′, the communication link between the virtual secretary system 30′ and the called-party side communication device 20′ is seamlessly switched between the mobile network communication link C2′ and the SIP communication link C1′ by the virtual secretary system 30′ of the present embodiment of the invention by way of multi-party call operation. Thus, the virtual secretary system 30′ can seamlessly switch the communication link by way of multi-party call operation without being noticed by the caller or the callee. Thus, when the location of the callee is switched between being inside and being outside the area A′, the communication between the caller and the callee will not be cut off, and quality communication is maintained.

Once the callee moves to the inside of the area A′, the communication system 10′ of the present embodiment of the invention, through the virtual secretary system 30′, converts the mobile network communication link C2′ incurring more communication cost to the SIP communication link C1′ incurring fewer communication cost, such that the communication cost between the caller and the callee is reduced.

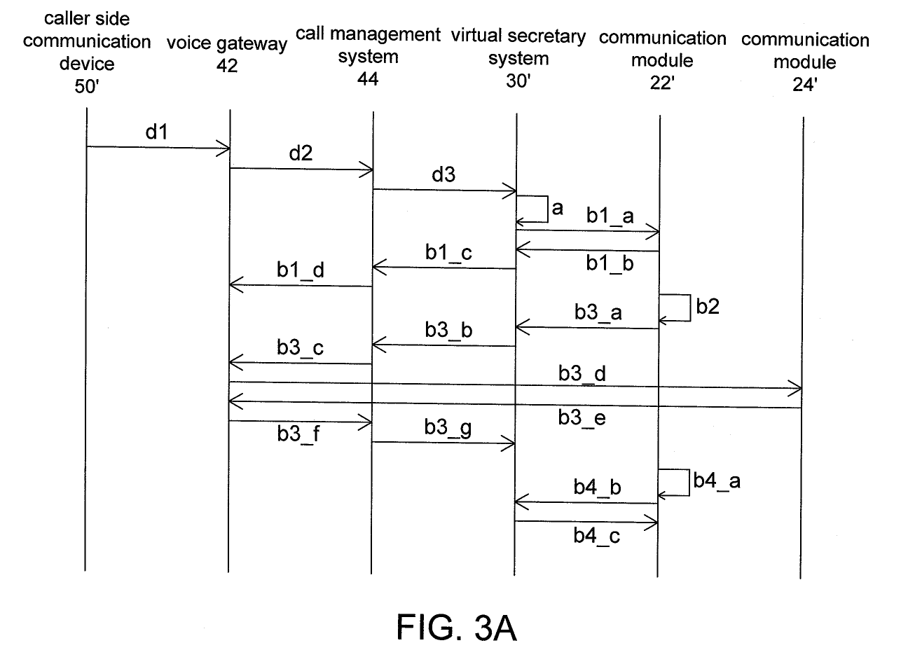

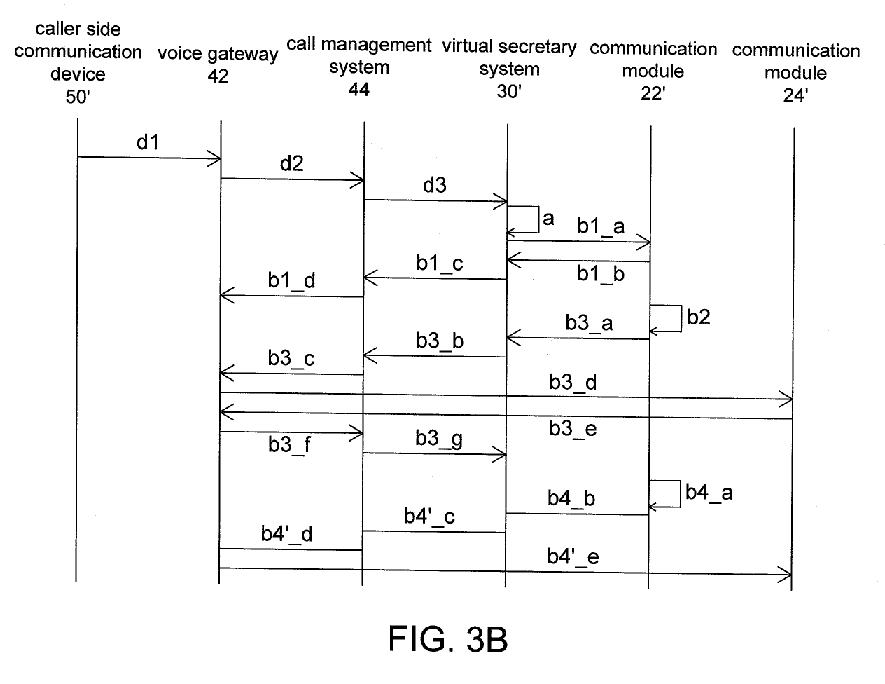

Referring to FIG. 3A, a sequential diagram of a communication method according to a first embodiment of the invention is shown. Before the communication method of the present embodiment of the invention is applied, the communication module 22′ of the called-party side communication device 20′ performs SIP registration to in the virtual secretary system 30′. The virtual secretary system 30′ provides extension information to register in the business telephone system 40′.

Firstly, as indicated in step (d1), the caller makes a call to the voice gateway 42 through the caller side communication device 50′ and inputs an extension number corresponding to the called-party side communication device 20′. Then, as indicated in step (d2) and step (d3), the voice gateway 42 converts the PSTN data to the SIP data and provides the converted data to the call management system 44. Then, the call management system 44 transfers the call made by the caller to the virtual secretary system 30′ according to the extension number called by the caller. Then, as indicated in step (a), the virtual secretary system 30′ connects the call made by the caller, and judges whether the called-party side communication device 20′ is inside the area A′ of the wireless local network.

Next, as indicated in step (b1_{—}a) and (b2_{—}b), when the called-party side communication device 20′ is inside the area A′, the virtual secretary system 30′ makes a call via IP to the communication module 22′ of the called-party side communication device 20′ through the wireless local network. When the callee answers the web call made by the virtual secretary system 30′, an SIP communication link C1′ is established between the virtual secretary system 30′ and the communication module 22′ for enabling the virtual secretary system 30′ and the communication module 22′ to communicate with each other. When the SIP communication link C1′ is established, the virtual secretary system 30′ sends back a message indicating the success of the establishment of the SIP communication link C1′ to the voice gateway 42 as indicated in step (b1_{—}c) and step (b1_{—}d). Thus, a three-party communication link is formed among the virtual secretary system 30′, the caller communication device 20′ and communication module 22′ for enabling the caller and the callee to communicate with each other.

Afterwards, as indicated in step (b2), the communication module 22′ judges whether the intensity of the signal of the wireless local network around the called-party side communication device 20′ is lower than the threshold value. In an operational application, when the callee moves to the boundary of the area A′, the intensity of the signal of the wireless local network around the communication module 22′ is detected by the communication module 22′ to be lower than the threshold value. Next, as indicated in step (b3_{—}a), the communication module 22′ requests the virtual secretary system 30′ to establish a mobile network communication link C2′ through the mobile network. Then, as indicate din step (b3_{—}b) and step (b3_{—}c), the virtual secretary system 30′ stores the mobile phone number corresponding to the communication module 24′, the virtual secretary system 30′, through call management system 44, provides the request of making a mobile phone and the mobile phone number to the voice gateway 42.

Then, as indicated in step (b3_{—}d) and (b3_{—}e), the voice gateway 42 makes a mobile phone to the communication module 24′. When the callee answers the mobile phone made by the voice gateway 42, a mobile network communication link C2′ is established between the voice gateway 42 and the communication module 24′ for enabling the virtual secretary system 30′ and the communication module 24′ to communicate with each other. When mobile network communication link C2′ is established, the voice gateway 42 further sends back a message indicating successful establishment of the mobile network communication link C2′ to the virtual secretary system 30′ as indicated in step (b3_{—}f) and step (b3_{—}g). Thus, a four-party communication link is formed among the caller side communication device 50′, the virtual secretary system 30′, and the communication modules 22′ and 24′ for enabling the caller and the callee to communicate with each other.

In an operational application, after step (b3_{—}g) is executed, the callee continues to move to the outside of the area A′. Meanwhile, the step (b4_{—}a) and the step (b4_{—}b) are executed, the communication module 22′ detects the intensity of the signal of the wireless local network around the communication module 22′ and informs the virtual secretary system 30′ that the intensity of the signal continues to be lower than the threshold value. Next, as indicated in step (b4_{—}c), the virtual secretary system 30′ terminates the SIP communication link C1′, such that a three-party communication link is formed among the caller side communication device 50′, the virtual secretary system 30′, the communication module 24′ for enabling the caller and the callee through the three-party communication link to communicate with each other.

The present embodiment of the invention is exemplified by an operational application in which the communication link between the virtual secretary system 30′ and the called-party side communication device 20′ is switched from an SIP communication link C1′ to a mobile network communication link C2′. However, the virtual secretary system 30′ is not limited to the switch between the SIP communication link C1′ and the mobile network communication link C2′. The communication link between the virtual secretary system 30′ and the called-party side communication device 20′ can be determined according to the operational application of the callee.

Referring to FIG. 3B, another sequential diagram of a communication method according to a first embodiment of the invention is shown. In another operational application, after step (b3_{—}g) is executed, the callee keeps moving to the inside of the area A′ as indicated in FIG. 2A. The communication module 22′ detects that the intensity of the signal of the wireless local network around the communication module 22′ continues to be higher than the threshold value. Meanwhile, after step (b4_{—}a) and step (b4_{—}b) are executed, the communication module 22′ detects and informs the virtual secretary system 30′ that the intensity of the signal of the wireless local network around the communication module 22′ continues to be higher than the threshold value. Next, as indicated in steps (b4′_{—}c)˜(b4′_{—}e), the virtual secretary system 30′, through the call management system 42, requests the voice gateway 42 to terminate the mobile network communication link C2′, such that a three-party communication link is formed among the caller side communication device 50′, the virtual secretary system 30′, and the communication module 22′ for enabling the caller and the callee to communicate with each other through the three-party communication link.

The wireless local network of the present embodiment of the invention is a wireless local network configured in a business for example, and the mobile network is a global system for mobile communication (GSM) network for example.

In the present embodiment of the invention, the communication system 10′ only comprises a virtual secretary system 30′ and a called-party side communication device 20′. However, the invention is not limited thereto, and the communication system 10′ may comprise two or more than two communication devices, which respectively communicate with two or more than two virtual secretary systems.

In one example, the communication system 10′ comprises N virtual secretary systems to which N communication devices respectively lodge SIP registration, wherein N is an integer larger than 1. The N virtual secretary systems are respectively registered in the business telephone system 40′ according to N different items of extension information. Thus, the N virtual secretary systems respectively answer the calls made by the N communication devices and respectively control the communication link between the N virtual secretary systems and the N communication devices.

In another example, M communication devices execute SIP registration to a virtual secretary system, wherein M is an integer larger than 1. The virtual secretary system can be registered in the business telephone system 40′ according to M different items of extension information. Thus, the business telephone system 40′ transfers each call made to the above M communication devices to the virtual secretary system, which, at the same time, answers the call made by the M communication devices and establishes the communication link between the virtual secretary system and the M communication devices.

The communication system of the present embodiment of the invention has a virtual secretary system which answers the incoming call for the mobile extension and establishes a mobile network or a wireless local network communication link for connecting the virtual secretary system to the mobile extension. The virtual secretary system further seamlessly switches the communication link between the virtual secretary system and the mobile extension to the communication link between the mobile network and the wireless local network by maintaining the communication link between the virtual secretary system via the mobile network of the mobile extension and the wireless local network. Compared with conventional communication system, the communication system of the invention seamlessly switches the communication link by way of multi-party call operation without being noticed by the caller or the callee. Thus, when the location of the callee is switched between being inside and being outside the coverage area of the wireless local network, the communication between the caller and the callee will not be cut off, and quality communication is maintained.

Furthermore, when the callee is moved to be inside the coverage of the wireless local network, the communication system of the present embodiment of the invention converts the mobile network communication link incurring more communication cost to the wireless network communication link incurring fewer communication cost. Compared with conventional communication system, the communication system of the invention further has the advantage of reducing the communication cost between the caller and the callee.

### Second Embodiment

In the present embodiment of the invention, the communication device is moved from outside the coverage of the wireless local network to inside the coverage of the wireless local network, and the communication link between the virtual secretary system and the communication device is seamlessly switched from the communication link on the mobile network to the communication link on the wireless local network.

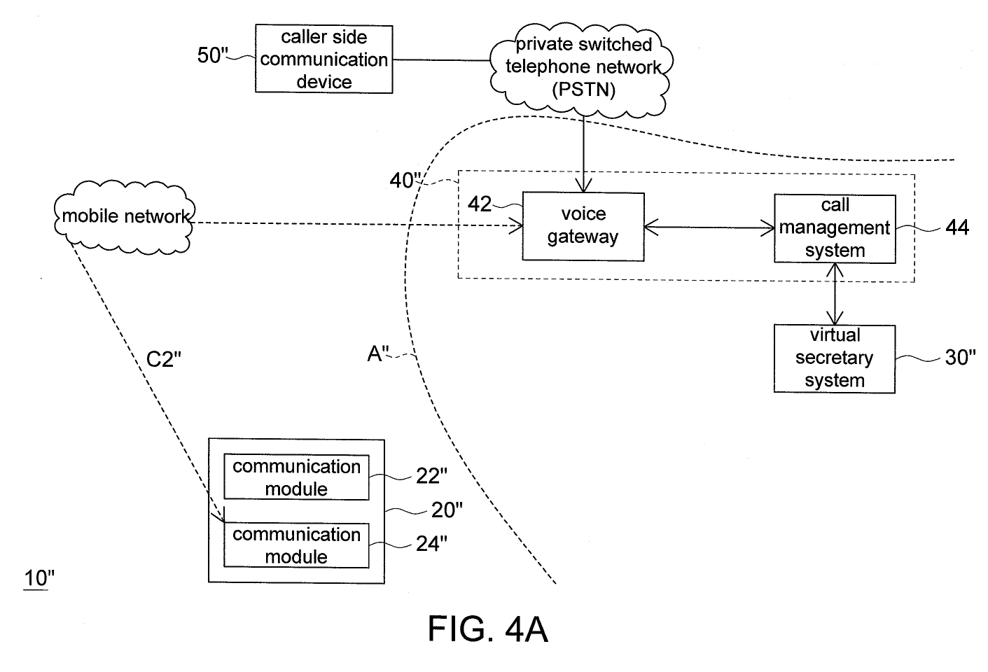

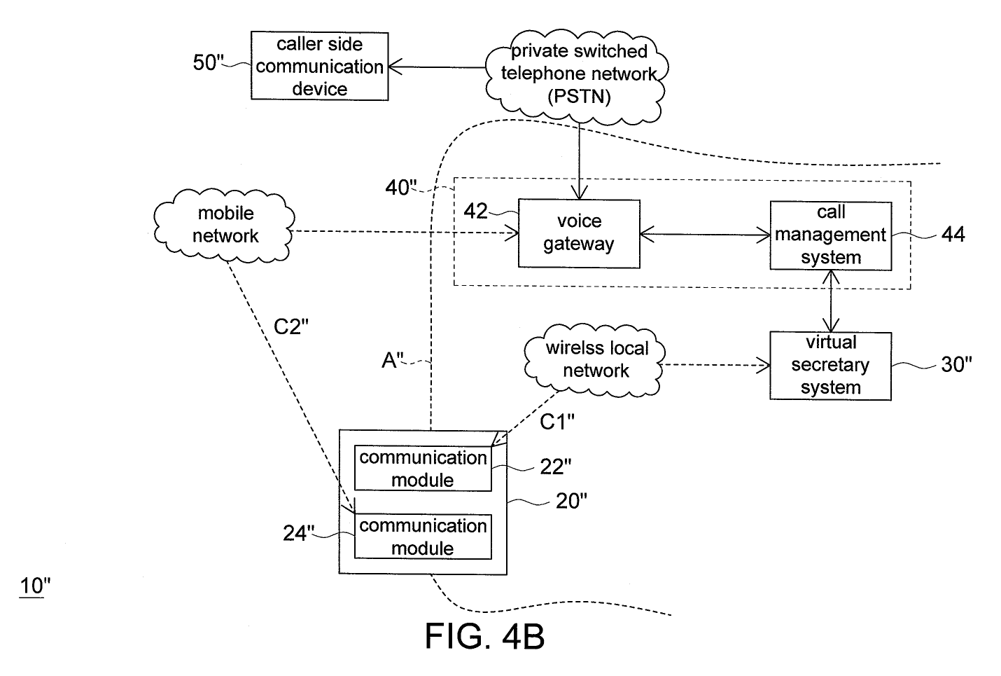

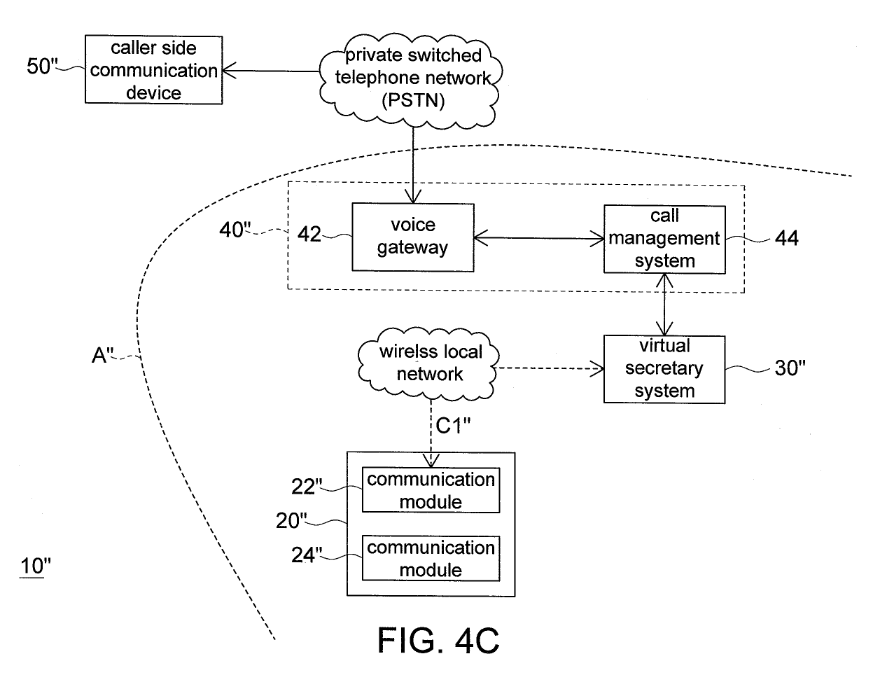

Referring to FIGS. 4A˜4C, a communication system according to second embodiment of the invention is shown. The communication system 10″ of the present embodiment of the invention differs with the communication system 10′ of the first embodiment in that the called-party side communication device 20″ to which the communication system 10″ of the present embodiment of the invention is connected is sequentially moved from outside the coverage area A″ of the wireless local network to inside the coverage area A″.

As indicated in FIG. 4A, the called-party side communication device 20″ is located outside the coverage area A″ of the wireless local network, and is unable to execute SIP registration to the virtual secretary system 30″. Meanwhile, the virtual secretary system 30″ judges whether the communication device 20″ is outside the area A″ according to the registration record of the called-party side communication device 20″, and makes a mobile phone call to the communication module 24″ through the mobile network. The virtual secretary system 30″ is further connected to the call made by the caller side communication device 50″, such that a three-party communication link is formed among the communication module 22″, the virtual secretary system 30″ and the caller side communication device 50″, and the caller and the callee communicate with each other through the three-party communication link.

As indicated in FIG. 4B, the called-party side communication device 20″ is located at the boundary of the area A″. Meanwhile, the communication module 22″ detects that the signal intensity of the wireless local network around is above a threshold value, and executes SIP registration to the virtual secretary system 30″. Thus, the virtual secretary system 30″ is informed that the signal intensity of the wireless local network around the communication module 22″ is higher than a threshold value, and makes a web call to the communication module 22″ through the wireless local network communication. After the callee holding the called-party side communication device 20″ answers the web call made by the virtual secretary system 30″, an SIP communication link C1″ is established between the virtual secretary system 30″ and the communication module 22″. Thus, a four-party communication link is formed among the virtual secretary system 30″, the communication module 22″, 24″ and the caller side communication device 50″, and the caller and the callee communicate with each other through the four-party communication link.

The virtual secretary system 30″ and the virtual secretary system 30′ of the first embodiment perform the same operation. That is, the virtual secretary system 30″ selectively terminates one of the SIP communication link C1″ and the mobile network communication link C2″ in response to the intensity of the signal of the wireless local network around the communication module 22″. When the callee is moved to be inside the area A″, and the intensity of the signal of the wireless local network around the communication module 22″ is higher than a threshold value, the virtual secretary system 30″ terminates the mobile network communication link C2″ as indicated in FIG. 4C. When the callee is moved to be outside the area A″, and the intensity of the signal of wireless local network around the communication module 22″ is lower than the threshold value, the virtual secretary system 30″ terminates the SIP communication link C1″ as indicated in FIG. 4A.

According to the above operation, the virtual secretary system 30″ of the present embodiment of the invention can further establish an SIP communication link C1″ through the wireless local network communication providing the mobile network communication link C2″ is already established and the virtual secretary system 30″ is informed that the intensity of the signal of the wireless local network around the communication module 22″ is substantially stable. Providing that the SIP communication link C1″ and the mobile network communication link C2″ are already established, and the communication module 22″ detects that the signal intensity of the wireless local network communication is higher than the threshold value, the virtual secretary system 30″ can further terminates the mobile network communication link C2″ such that the communication link between the virtual secretary system 30″ and the communication module 22″ can be seamlessly switched from the mobile network communication link C2″ to the SIP communication link C1″.

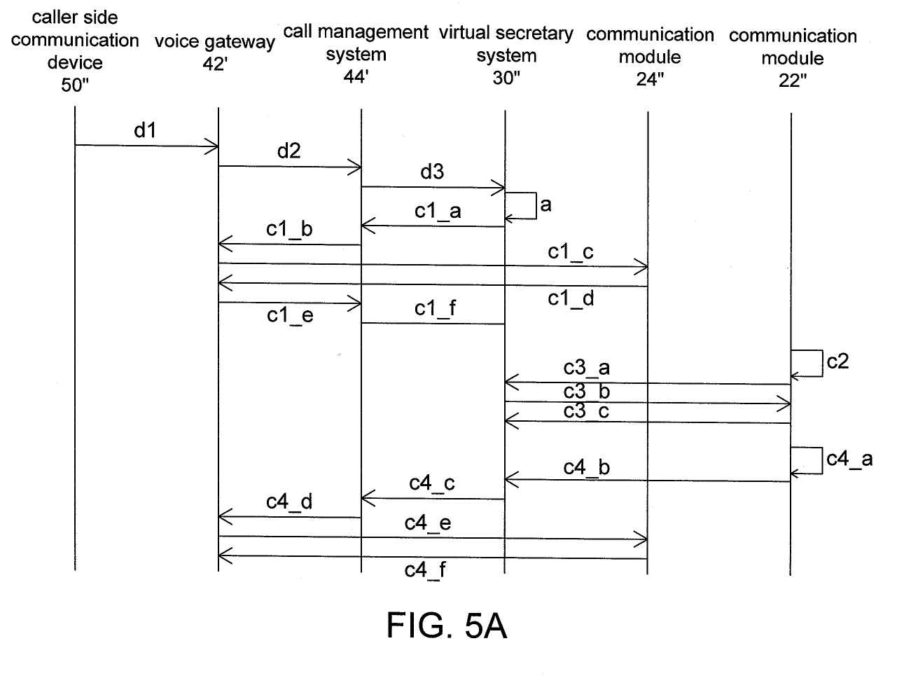

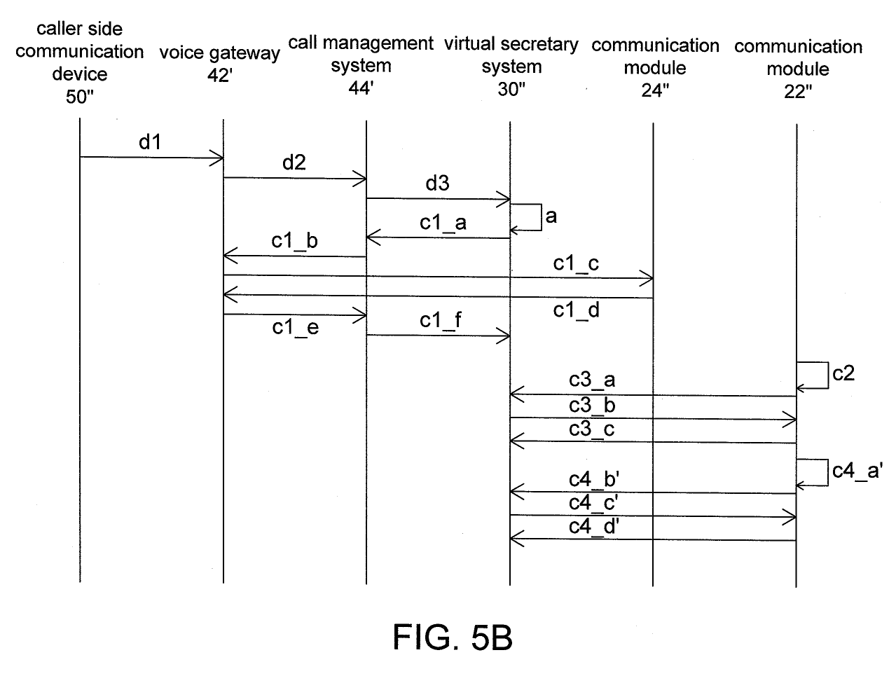

Referring to FIG. 5A, a sequential diagram of a communication method according to a second embodiment of the invention is shown. The communication method of the present embodiment of the invention differs with the communication method of the first embodiment in that in step (a), the virtual secretary system 30″ judges whether the called-party side communication device 20″ is located outside the area A″ of the wireless local network. Next, the method proceeds to step (c1), the mobile network communication link C2″ is established. Step (c1) comprises steps (c1_{—}a)˜(c1_{—}c). When the called-party side communication device 20″ is located outside the area A″, the virtual secretary system 30″ requests the voice gateway 42′ through the call management system 44′ to make a mobile phone to the communication module 24″ of the called-party side communication device 20″. Next, the method proceeds to step (c1_{—}d), when the callee answers the mobile phone called by the virtual secretary system 30″, a mobile network communication link C2″ is established between the virtual secretary system 30″ and the communication module 24″ for enabling the virtual secretary system 30″ and the communication module 24″ to communicate with each other. When mobile network communication link C2″ is established, the virtual secretary system 30″ further requests the voice gateway 42′ through the call management system 44′ to send the message indicating successful establishment of the mobile network communication link C2″ back to the virtual secretary system 30″ as indicated in steps (c1_{—}e) and (c1_{—}f).

Next, as indicated in step (c2), the communication module 22″ judges whether the signal intensity of the wireless local network around the called-party side communication device 20″ is zero. In an operational application, the callee is moved to the edge of the area A″, such that the communication module 22″ detects that the signal intensity of the wireless local network around the called-party side communication device 20″ is higher than a threshold value. When the signal intensity of the wireless local network around the called-party side communication device 20″ is higher than a threshold value, step (c3_{—}a) is executed, the communication module 22″ lodges SIP registration to the virtual secretary system 30″. Then, the method proceeds to steps (c3_{—}b) and (c3_{—}c), an SIP communication link C1″ is established by the virtual secretary system 30″. Thus, a four-party communication link is formed among the caller side communication device 50″, the virtual secretary system 30″, and the communication modules 22″ and 24″ for enabling the caller and the callee to communicate with each other.

In an operational application, after step (c3_{—}c), the callee continues to move to the inside of the area A″. Meanwhile, steps (c4_{—}a) and (c4_{—}b) are executed, the communication module 22″ detects that the signal intensity of the wireless local network around the communication module 22″ continues to be higher than the threshold value and informs the virtual secretary system 30″ accordingly. Next, as indicated in steps (c4_{—}c)˜(c4_{—}f), the virtual secretary system 30″ request the voice gateway 42′ through the call management system 44′ to terminate the mobile network communication link C2″. Thus, a three-party communication link is formed among the caller side communication device 50″, the virtual secretary system 30″, and the communication module 22″ for enabling the caller and the callee through the three-party communication link to communicate with each other.

The present embodiment of the invention is exemplified by an operational application in which the communication link between the virtual secretary system 30″ and the called-party side communication device 20″ is switched from a mobile network communication link C2″ to an SIP communication link C1″. However, the virtual secretary system 30′ is not limited to switching the mobile network communication link C2″ to the SIP communication link C1″, and the communication link between the virtual secretary system 30″ and the called-party side communication device 20″ can be switched in response to the callee's various operational applications. In another operational application, after the step (c3_{—}c), the callee continues to be moved to the outside of the area A′ as indicated in FIG. 4A. As indicated in FIG. 5B, after step (c3_{—}c) is executed, the communication method of the present embodiment of the invention proceeds to steps (c4_{—}a′) and (c4_{—}b′), the communication module 22″ detects that the signal intensity of the wireless local network around the communication module 22″ continues to be lower than the threshold value and informs the virtual secretary system 30″ accordingly. Next, the method proceeds to step (c4_{—}c′) and (c4_{—}d′), the virtual secretary system 30″ requests the voice gateway 42′ through the call management system 42′ to terminate the SIP communication link C1″. Thus, a three-party communication link is formed among the caller side communication device 50″, the virtual secretary system 30″, and the communication module 24″ for enabling the caller and the callee to communicate with each other through the three-party communication link.

The communication system of the present embodiment of the invention has a virtual secretary system which replaces a mobile extension in answering the incoming call, establishes a mobile network communication link or a wireless local network communication link for linking the virtual secretary system and the mobile extension, and seamlessly switches the communication link between the virtual secretary system and the mobile extension between the mobile network communication link and the wireless local network communication link. Thus, the invention provides a communication system capable of seamlessly switching the communication link by way of multi-party call function without being noticed by the caller or the callee for preventing the continuity of the communication between the caller and the callee being cut off and for maintaining the quality of communication. Furthermore, when the callee moves to be inside the coverage area of the wireless local network, the communication system of the invention converts the mobile network communication link incurring more communication cost to the wireless network communication link incurring fewer communication cost, hence having the advantage of reducing the communication cost between the caller and the callee.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A communication system used for enabling a caller side communication device and a called-party side communication device to communicate with each other, wherein the called-party side communication device comprises a first communication module and a second communication module, the first communication module and the second communication module respectively support a wireless local network communication and a mobile network communication, the communication system comprises:
a virtual secretary system for judging whether the called-party side communication device is inside an area of a wireless local network and determining whether to establish a first communication link on the wireless local network for enabling the virtual secretary system and the first communication module to communicate with each other or to establish a second communication link on a mobile network for enabling the virtual secretary system and the second communication module to communicate with each other; and
a business telephone system for enabling the caller side communication device and the virtual secretary system to communicate with each other in response to a ringing event;
wherein, when the caller side communication device and the virtual secretary system communicate with each other, the virtual secretary system further establishes one of the first communication link and the second communication link for enabling the caller side communication device and the called-party side communication device to communicate with each other;
wherein, when the caller side communication device and the virtual secretary system communicate with each other and the location of the called-party side communication device is switched between being inside and being outside the area, the virtual secretary system, by way of multi-party call operation, switches the first communication link to the second communication link or switches the second communication link to the first communication link, such that the caller side communication device and the called-party side communication device keep communicating with each other.

2. The communication system according to claim 1, wherein when the called-party side communication device is inside the area, the virtual secretary system establishes the first communication link on the wireless local network for enabling the virtual secretary system and the first communication module to communicate with each other, such that a three-party call operation is formed among the first communication module, the virtual secretary system and the business telephone system, and the called-party side communication device and the caller side communication device communicate with each other through the three-party call operation.

3. The communication system according to claim 2, wherein after the first communication link is established, when a signal intensity of the wireless local network, on which the called-party side communication device operates communication, is lower than a threshold value, the virtual secretary system establishes the second communication link on the mobile network for enabling the virtual secretary system and the second communication module to communicate with each other, such that a four-party call operation is formed among the first communication module, the second communication module, the virtual secretary system and the business telephone system, and the called-party side communication device and the caller side communication device communicate through the four-party call operation.

4. The communication system according to claim 3, wherein after the first communication link and the second communication link are established, the virtual secretary system terminates the first communication link if the signal intensity continues to be lower than the threshold value.

5. The communication system according to claim 1, wherein when the called-party side communication device is outside the area, the virtual secretary system establishes the second communication link on the mobile network for enabling the virtual secretary system and the second communication module to communicate with each other, such that a three-party call operation is formed among the second communication module, the virtual secretary system and the business telephone system, and the called-party side communication device and the caller side communication device communicate by way of the three-party call operation.

6. The communication system according to claim 5, wherein after the second communication link is established, when the called-party side communication device is inside an area of the wireless local network, the virtual secretary system establishes the first communication link on the wireless local network for enabling the virtual secretary system and the called-party side communication device to communicate with each other, such that a four-party call operation is formed among the first, the second communication module, the virtual secretary system and the business telephone system, and the called-party side communication device and the caller side communication device communicate by way of the four-party call operation.

7. The communication system according to claim 6, wherein after the first communication link and the second communication link are established, the virtual secretary system further terminates the second communication link if a signal intensity of the wireless local network continues to be higher than a threshold value.

8. A communication method, comprising:
(a) judging whether a called-party side communication device is inside an area of a wireless local network in response to a ringing event activated by a caller side communication device;
(b) establishing a first communication link through a wireless local network when the called-party side communication device is inside the area for enabling the caller side communication device and the called-party side communication device to communicate with each other;
(c) establishing a second communication link through a mobile network communication when the called-party side communication device is outside the area for enabling the caller side communication device and the called-party side communication device to communicate with each other; and
(d) switching the first communication link to the second communication link or switching the second communication link to the first communication link by way of a multi-party call operation when the caller side communication device and the called-party side communication device communicate with each other and the location of the called-party side communication device is switched between being inside and being outside the area, such that the caller side communication device and the called-party side communication device keep communicating with each other.

9. The communication method according to claim 8, wherein step (b) comprises:
(b1) establishing the first communication link for enabling the caller side communication device and the called-party side communication device to communicate with each other;
(b2) judging whether the called-party side communication device is inside the area of the wireless local network; and
(b3) executing the step (c) at the same time if the called-party side communication device is outside the area.

10. The communication method according to claim 9, wherein after the step (b3), the method comprises:
(b4) terminating the first communication link if the signal intensity continues to be lower than a threshold value.

11. The communication method according to claim 8, wherein step (c) comprises:
(c1) establishing the second communication link for enabling the caller side communication device and the called-party side communication device to communicate with each other;
(c2) judging whether the called-party side communication device is inside the area of the wireless local network and
(c3) executing the step (b) at the same time if the called-party side communication device is inside the area.

12. The communication method according to claim 11, wherein after step (c3), the method comprises:
(c4) terminating the second communication link if an intensity of the signal continues to be higher than a threshold value.
